(19) United States
(12) Patent Application Publication
(10) Pub. No.: US 2009/0272019 A1
(43) Pub. Date: Nov. 5, 2009

(54) Hunting mannequin

(76) Inventor: Greg Espenkotter, Theodosia, MO (US)

Correspondence Address: LATHROP & GAGE LLP, 1845 S. NATIONAL, P.O. BOX 4288, SPRINGFIELD, MO, 65808-4288, US

(21) Appl. No.: 12/387,436

(22) Filed: May 1, 2009

Related U.S. Application Data
(60) Provisional application No. 61/126,135, filed on May 1, 2008.

(51) Int. Cl. A01M 31/00

(52) U.S. Cl. 43/1

(57) ABSTRACT

The instant invention is a hunting mannequin formed of concentric metal rings with an overlying skin material. Chains between the skeleton rings space the rings apart to deploy the mannequin in a substantially upright position when the mannequin is mounted in a hunting blind. The rings and associated spacer chains can be compressed to substantially flatten the mannequin for transportation and storage. Another embodiment of the invention substitutes the concentric rings with a spring member which allows the mannequin to self-deploy.

### RELATED APPLICATION

This Application claims the priority of the provisional patent application Ser. No. 61/126,135 filed May 1, 2008, and incorporates the disclosure of the referenced application herein.

### BACKGROUND OF THE INVENTION

The present invention is a collapsible mannequin or dummy, more particularly the invention is a collapsible torso approximating the upper torso of a human being which is intended for use by hunters to desensitize game animals to the presence of a person in a hunting location, such as a tree stand. The mannequin is collapsible, light weight, durable and inexpensive to manufacture.

Game animal hunters use a variety of buildings, structures, tree mounted platforms, elevated boxes and the like, all generally referred to as “blinds” to conceal themselves from their prey. There are numerous examples of such blinds, including tree mounted platforms commonly used by archers to hunt deer, elk and other big game. Similar stands are used by hunters virtually everywhere in the world. Waterfowl hunters commonly conceal themselves in a highly camouflaged blind, generally near a body of water. Pre-manufactured blinds are common and are generally available from most hunting retail stores. These often are plastic boxes which are simply placed on hunting grounds, or may be elevated on poles or platforms.

Many hunters leave their blinds in place year round and others allow them to occupy the hunting grounds shortly before and after hunting seasons. Regardless, there are long intermittent periods where the blinds are unoccupied. Accordingly, one school of thought is that animals sense the presence of hunters in the blinds and are less wary during those periods of time when the blind is unoccupied. Accordingly, a variety of dummies and mannequins have been created for the specific purpose of placing them in the blind when it is unoccupied by a human being with the stated purpose of desensitizing the game animals to the presence of an occupant within the blind.

Many of the mannequins that have been previously designed are complex with numerous moving parts, such as that disclosed in U.S. Pat. No. 6,079,139 to Berry which includes a mannequin head that moves with the breeze. Another complex mannequin is disclosed at Application 2004/0159038 to Hageman which includes scent dissemination, sound generation and movement systems.

At the other end of the spectrum are very simple mannequins such as U.S. Application 2003/0029074 to Volz, U.S. D463,523 to McCombs, and U.S. Pat. No. 5,682,701 to Gammon. These mannequins are static and are not articulated, have no mechanical features and are not intended to disperse scents or create movement or sound. Each of the known mannequins, however, have drawbacks and limitations which make them difficult to use or maintain, expensive to purchase or too fragile for extended outdoor use.

Known mannequins are either inflatable or formed of rigid material, such as cardboard, wood or similar materials. The inflatable mannequins are generally suitable for many hunters because they are extremely lightweight and can be compressed or folded to small dimensions for transport to and from the blind. This is particularly important for certain hunting methods such as bow hunting where the hunter often packs in on their back all of the equipment they need. The primary drawback to inflatable mannequins, however, is that they tend to develop leaks when left on a blind for long periods of time. Inflatable mannequins are also prone to leak air at seams due to repeated inflation, deflation and packing for transport. Moreover, changes in atmospheric pressure can cause the mannequins to sag or partially deflate. For blinds that are positioned in trees, inflatable mannequins generally suffer punctures from limbs, falling branches and the like. The inflatable mannequins can be deflated when the hunter is on the blind which generally solves the problem of mannequin placement during periods of hunting.

The rigid mannequins avoid all of the stated deficiencies of the inflatable mannequins. However, they do have unique problems. Rigid mannequins are difficult to transport to and from the blind. Moreover, there is a significant problem when a hunter occupies the blind because the rigid mannequin has to be removed from the blind and substantially camouflaged or otherwise hidden. Rigid mannequins are difficult to hoist into an elevated tree blind and their overall weight makes them cumbersome and difficult to carry and manipulate. This is particularly problematic in an elevated tree blind where the hunter has to move a relatively heavy object. The instant invention overcomes the stated deficiencies of both the rigid and inflatable hunting mannequins.

### BRIEF DESCRIPTION OF THE INVENTION

The present invention is a collapsible hunting mannequin. It is preferred that the mannequin comprise only the torso and head of a human being and the inclusion of arms below the shoulders is optional. The mannequin comprises an internal collapsible skeleton and a tough but foldable skin, manufactured from canvas, heavy plastic, durable cloth or similar flexible materials. An internal skeleton is created by attaching a plurality of metal rings to the inner surface of the skin material. The rings vary in size such that each ring approximates the size and shape of a particular cross section of a human torso. For example, a lowermost ring approximates the waist, the next lowest ring approximates the stomach area, the next ring approximates the chest, and the next ring approximates the shoulders. Smaller metal rings forming the skeleton portion for each arm if arms are to be included on the mannequin. Metal rings of varying circumference are stacked to form the neck and head of the mannequin. The number of rings can be varied to change the overall appearance of the mannequin.

The skin material is cut into a pattern to resemble a human torso. The skeleton rings may be sewn into the material or fastened with other conventional fasteners, such as hook and loop, snap and loop, or similar connectors. It is the orientation of the skeleton rings with material interposed each pair of rings which allows the mannequin to be substantially collapsed along a vertical line. In one embodiment of the invention where the skeleton is formed of separate rings, it may be necessary to interpose rigid spacers between each pair of rings for the mannequin to maintain an expanded orientation upon deployment. In the preferred embodiment, however, the rigid spacing rods are replaced with metal chain which makes mannequin easier to collapse and transport. It is preferable the mannequin to have several tethers which allow it to be attached to the tree, the blind or some other static portion of the blind to prevent the mannequin from blowing away or collapsing.

When the mannequin is not in use, it can be substantially collapsed. When collapsed, it may be necessary to use ties to keep the mannequin from springing into the fully deployed position.

Overall, the mannequin is extremely light weight, and can be made of very durable material. Because it is not inflated, puncturing is not problematic. It is easy to pack when collapsed. Further, it is inexpensive to manufacture and can be made of readily available materials.

Accordingly, the mannequin as disclosed and claimed herein overcomes the deficiencies of both inflatable and rigid mannequins.

### BRIEF DESCRIPTION OF THE DRAWINGS

A more complete understanding of the present invention may be had by reference to the following detailed description in conjunction with the accompanying drawings.

FIG. 1 is a perspective view of the preferred embodiment of the mannequin.

FIG. 2 is a cross-sectional view of the mannequin in FIG. 1.

FIG. 3 is a top view of the mannequin of FIG. 1.

FIG. 4 is a perspective view of the mannequin of FIG. 1 in the collapsed configuration.

### DETAILED DESCRIPTION OF THE PREFERRED EMBODIMENT

Referring now generally to the FIGs., a collapsible hunting mannequin 102 is shown as further disclosed and described. The mannequin has two primary components, an internal skeleton comprising of plurality of concentric rings 104, 106, 108, 110 and 112 and a flexible outer covering or skin 114.

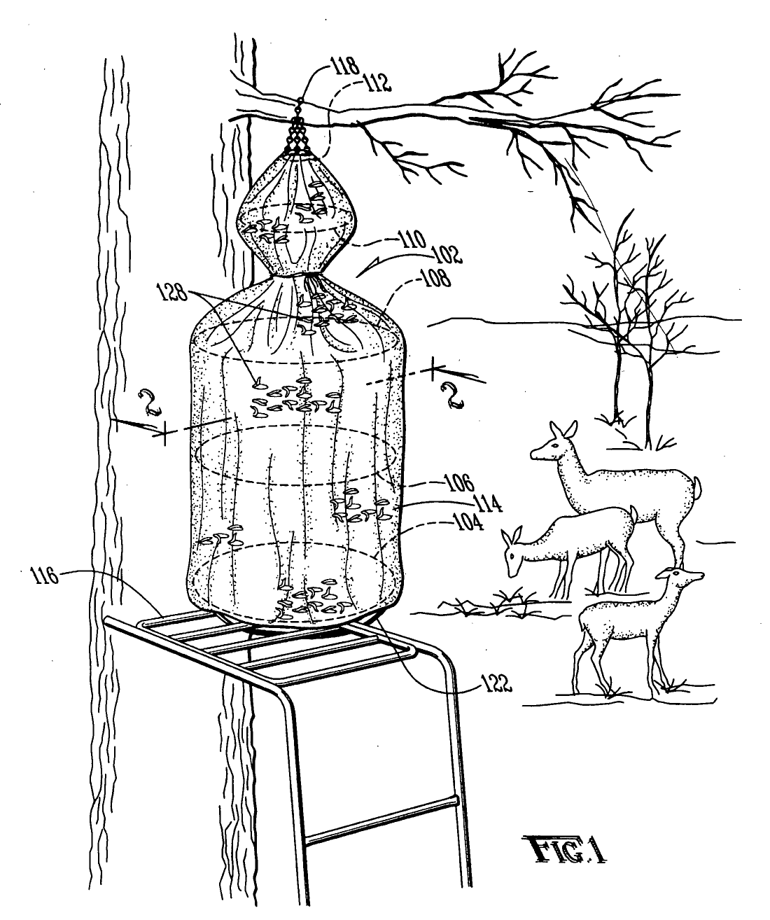

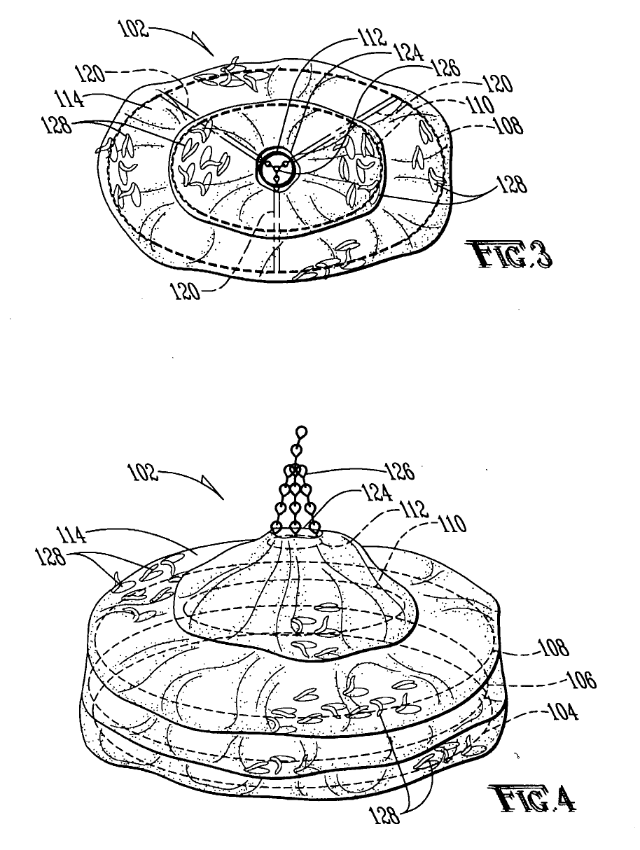

Referring to FIGS. 1, 2 and 3 the rings 104-112 are generally round or oval. As best seen in FIG. 3, the rings 104-112 may also be provided with any number of concavities or convexities to emulate a human torso. The rings 104-112 are spaced apart and bound to the external skin 114, preferably manufactured from canvas, heavy plastic, durable cloth or similar materials. The concentric rings 104-112 are spaced apart and may be sewn directly into the skin 114 or fastened with other mechanisms, such as hook and loop or snap and fasteners.

As shown in FIG. 3 rings of varying size are used to form the torso, appendages, the neck and head. It is to be understood that any number of rings can be used dependent upon the desired detail of the appearance of the mannequin. As described, the mannequin can collapse into a substantially flat orientation as shown in FIG. 4. Accordingly, spacers are preferably provided and attached between each adjacent pair of rings or may be sewn directly into the skin between each pair of adjacent rings. The preferred spacers are light weight chain 120, sometimes referred to as hobby chain. The chain 120 is preferred because it readily collapses during transport and storage of the mannequin while providing enough weight to maintain the mannequin in a deployed or open orientation. This occurs because the weight of the chains 120 pulls generally downward on the uppermost ring to which the chain 120 is connected. The flexibility of the chain 120 also allows realistic and natural movement and flexion of the mannequin when in use than can be achieved with rigid connectors. Moreover, the chain is inexpensive and extremely durable. When the mannequin is collapsed, it may be necessary to bind it into its flat collapsed orientation with tethers or other fasteners 122.

During use the mannequin is placed in a blind and attached to a tree branch 124, or rigid member of the blind 116 itself. It is preferred that the mannequin 102 hangs in a suspended fashion with the attachment point at or near the mannequin head as shown in FIG. 1. A number of fasteners, preferably chain 126 passes through an opening 124 formed through the skin 114 at the peak of the mannequin's head. A ring 112 is fastened at this opening 124 to add rigidity and to prevent the chain 126 from tearing the skin 114. This allows the mannequin to be moved about by the wind which creates the desired movement within the blind when it is unoccupied by a human. The weight of the rings 104-112 and attached chains 120 cause the mannequin to remain open or deployed.

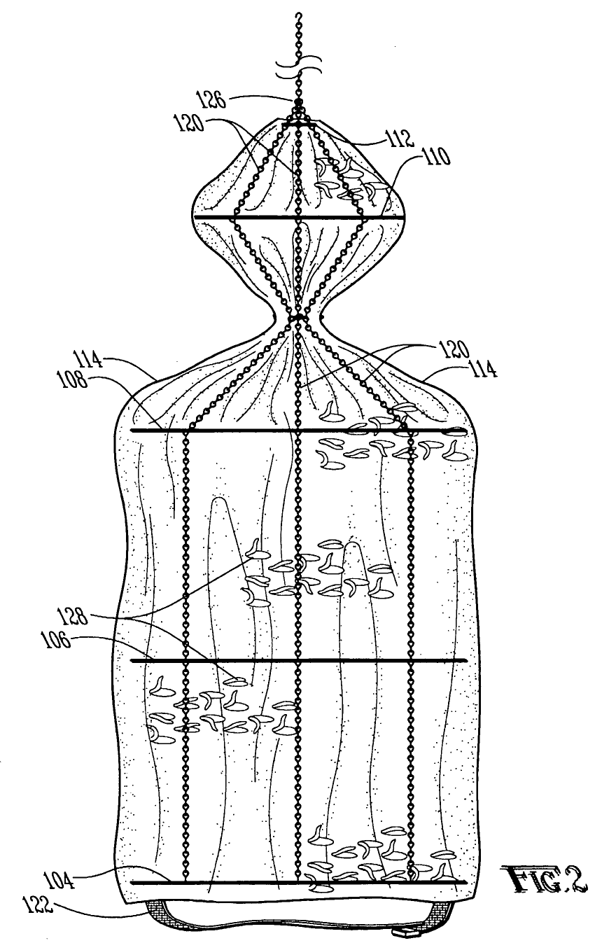

As best shown in FIGS. 1 and 2, the skin material can be decorated with any appearance, most likely camouflage material or other hunting clothes. It is preferred that the skin material 114 is camouflaged and includes perforations 128, decorations or additional materials to make the surface uneven, a technique which results in a type of camouflage referred to as a ghillie suit. A face may be shown or partially shown on the head region. Where the skin is plastic, the decoration may be molded directly in the plastic. Where canvas or other material, the decoration may be painted or applied.

As best shown in FIG. 3, the skeleton rings 104-112 are slightly different shapes and sizes to be specifically formed to replicate specific portions of the torso. The ring 106 that would generally be provided at the abdomen portion of the torso may include at the rear or back portion of the ring, a concavity manufactured within the periphery of the ring to substantially mold the torso around a tree. This is particularly beneficial when the mannequin is being used on a hunting tree stand. It allows the mannequin to conform around the tree to diminish the likelihood that the mannequin will fall over or be forcibly blown from the stand by wind. Tethers 122 may be provided which are attached directly to a ring or to the cloth skin for tying or otherwise attaching the mannequin to the hunting stand or blind.

It is to be understood that the rings disclosed herein are for illustration only and they can be formed in any variety of configurations, sizes and shapes. Accordingly, different mannequins can be manufactured by simply changing the size and orientation of the rings. For example, a hunter may desire to utilize a mannequin that is generally of the same size and dimensions. A large hunter may prefer a larger mannequin while a small hunter may prefer a smaller mannequin. These size differentiations can easily be accommodated by simply changing the size of the ring and the amount of covering material. Further, it may be desirable to have separate independent arms that can be pre-positioned, for example to provide the appearance of a hunter holding a weapon. Again, these can be easily accommodated by adding additional rings to extend the arms below the shoulder region.

Tethers 122 may be optionally provided with the mannequin to allow it to be secured to the tree, the blind or other static items. Because the mannequin can easily be collapsed and stowed, it is ideal for tree stands and other locations where the mannequin cannot be easily hidden when the hunter is place. The hunter simply collapses the mannequin and either sits on it or hangs it from a convenient branch or hook.

It should be understood that this invention is not limited to the embodiments disclosed herein but is capable of numerous rearrangements, modifications and substitutions without departing from the spirit of the inventions which is only limited by the appended claims.

What is claimed is:

1. A hunting mannequin comprising an inner skeleton formed of a plurality of concentric rings and a skin material placed over and secured to the concentric rings.

2. The hunting mannequin of claim 1 wherein the concentric rings are formed, spaced apart and oriented to replicate a human torso.

3. The hunting mannequin of claim 1 further comprising a plurality of rigid spacing bars positioned between each pair of concentric rings.

4. The hunting mannequin of claim 1 further comprising a plurality of chains attached between each pair of concentric rings.

5. The hunting mannequin of claim 1 further comprising a plurality of tethers for fastening the mannequin to a hunting blind.

6. The hunting mannequin of claim 1 wherein the skin material is decorated in a camouflaged pattern.

7. The hunting mannequin of claim 6 wherein the camouflage skin material is a ghillie suit.

8. The hunting mannequin of claim 1 further comprising a mechanism for suspending the mannequin from an elevated structure.

9. A hunting mannequin comprising an inner skeleton formed of a plurality of concentric rings, each ring varying in size and spaced apart to replicate the torso and head of a human, and a skin material placed over and secured to the concentric rings, and wherein the mannequin is placed into a hunting blind during periods when the blind is not occupied by a hunter for desensitizing game animals to human presence and movement.

10. The hunting mannequin of claim 10 wherein the concentric rings are formed, spaced apart and oriented to replicate a human torso, head and arms.

11. The hunting mannequin of claim 10 further comprising a plurality of rigid spacing bars positioned between each pair of concentric rings.

12. The hunting mannequin of claim 10 further comprising a plurality of chains attached between each pair of concentric rings which assist in holding the skin material in place and maintain the desired spacing of the rings when the mannequin is in use and which allow the mannequin to substantially collapse flat when not in use.

13. The hunting mannequin of claim 10 further comprising a plurality of tethers for fastening the mannequin to a hunting blind.

14. The hunting mannequin of claim 10 wherein the skin material is decorated in a camouflaged pattern.

15. The hunting mannequin of claim 14 wherein the camouflage skin material is a ghillie suit.
